(19) United States
(12) Patent Application Publication
(10) Pub. No.: US 2012/0140348 A1
(43) Pub. Date: Jun. 7, 2012

(54) Kiser coupler

(76) Inventor: Joseph K. Kiser, Powder Springs, GA (US)

(21) Appl. No.: 11/787,737

(22) Filed: Apr. 17, 2007

(51) Int. Cl. G02B 7/02

(52) U.S. Cl. 359/829; 359/819

(57) ABSTRACT

An improved mount for interfacing an Aimpoint optical gun site and Aimpoint optical magnifier. An apparatus and method for quickly, and securely attaching an Aimpoint magnifier to an Aimpoint optical gun site using the circumferential cut present on the rear of the external housing. This invention relies on a spring tensioned lever and the cylindrical housing provided by my design to securely retain an Aimpoint magnifier to the housing of an Aimpoint. My invention also provides for adjusting the host firearms point of impact by changing the orientation of the noise suppressor in relation to the host firearms bore.

### BACKGROUND OF THE INVENTION—FIELD OF INVENTION

This invention generally relates to optical sighting system for firearms, specifically to systems which facilitate the mounting of a secondary optical magnifier which is to be used in conjunction with a primary non magnified optic.

### BACKGROUND OF THE INVENTION—PRIOR ART

Previous systems exist for mounting secondary optical magnifiers which are to be used in conjunction with a primary optic. The invention which I am claiming as novel is design specifically to work with the Aimpoint 3x magnifier. The Aimpoint 3x magnifier is designed to provide three power magnification for long range target identification and acquisition when used in conjunction, but not limited to, a standard Aimpoint Comp M3. A secure, quickly attachable or detachable mount which does not mandate a large external profile is what the end user of this product requires. LaRue Tactical, Aimpoint and Sampson have all created mounts which will secure the Aimpoint 3x magnifier to a 1913 Picatinny spec rail but fail to provide the optimal solution.

LaRue tactical 3x magnifier, LT-602, requires the use of limited space located on the 1913 spec Picatinny rail present on top of most military M4 and M16 rifles. Further the mount is not quick to remove as a tensioned throw lever must be utilized in order to remove the mount, optic combination. The height, structure and required attachment method of the mount make it difficult for the user to quickly remove the optic mount combination from a pocket or other small utility pouch.

The Sampson Quick Flip (TM) mount for the Aimpoint 3x magnifier has one unique characteristic. Sampson's mount allows the user an option of flipping the Aimpoint to the side when the three power magnification is not needed by depressing a lever and twisting the magnifier and mount on its axis away from the optical sighting plane. Once the Aimpoint 3x magnifier is displaced from it primary use position it flops around on the side and presents itself to being stuck on surfaces, such as door frame, as military and police members enter or egress from building.

Moro vision produces Monoloc™ Universal Adapter (MVA-002). This design is not designed to be used with an Aimpoint 3x magnifier and fails to provide a method to quickly release the attached a magnifier or other optical device to the AIMPOINT optical gun site. The tension levers which are the heart of the design are slow to operate and will not attach to the limited “real estate” provided on the rear of an Aimpoint.

### BACKGROUND OF INVENTION—OBJECTS AND ADVANTAGES

Accordingly several objects and advantages of the present invention are
   (a) to allow for the fast attachment and detachment of a secondary optical magnifier to an Aimpoint
   (b) to provide for a secure mounting system which will interface with existing Aimpoint body geometry
   (c) to allow for a mount which will minimize the additional profile added to the diameter of the optical magnifier
   (d) to provide an apparatus and method of attachment which do not require the use of a 1913 Picatinny rail as a mounting surface.

Still further objects and advantages will become apparent from a consideration of the ensuing description and drawings.

### SUMMARY

The present invention provides an apparatus and method for easily, and quickly attaching an Aimpoint magnifier to an Aimpoint optical gun site. A cylindrical housing, which serves as an optical mount, is provided with a screw which when tightened causes the metal housing to compress about the body an Aimpoint magnifier. A lever under spring pressure is provided on the front end of the optical mount. This lever serves the function of interlocking with the grove located about the rear of an Aimpoint optical gun site and prevents the magnifier, mount combination from disengaging with the host Aimpoint optic. When the handle of the lever is depressed the front area of the lever is raise from its resting point inside of the mount so that it is not obstructing the forward opening of the optical mount. With the obstruction removes from its path the Aimpoint magnifier with my optical mount may then be slip over the rear of an Aimpoint optical gun site. An internal shoulder is proved inside of the optical mount to stop the forward progression of the optical mount and magnifier combination. Once seated the lever is released to slide into its resting position which is the circumferential groves about the body of an Aimpoint optical gun site.

### DRAWINGS

The novel features believed to be characteristic of the invention, together with further advantages thereof, will be better understood from the following description considered in connection with the accompanying drawings in which a preferred embodiment of the present invention is illustrated by way of example. It is to be expressly understood, however, that the drawings are for the purpose of illustration and description only and are not intended as a definition of the limits of the invention.

FIG. 1 shows a horizontal side view of the proposed mount, the screw and latch locations are further depicted;

FIG. 2 shows a frontal view of the mount which indicates the location of the forward shoulder and roll pin hole;

FIG. 3 is a horizontal side view of the proposed mount rotated 180 degrees from its position in FIG. 1;

FIG. 4 shows a bottom and rear view of the proposed mount, also depicted is the retention cut;

FIG. 5 shows a top view of the proposed lever;

FIG. 6 shows a rear view of the proposed lever in FIG. 5;

FIG. 7 shows a vertical side view of the lever spring;

FIG. 8 shows a vertical side view of the proposed roll pin which works in conjunction with the lever depicted in FIG. 5;

FIG. 9 shows a vertical side view of a screw;

FIG. 10 shows a preassembly view and orientation of an Aimpoint optical gun right on the left followed by a Kiser couplet mount and an Aimpoint 3x magnifier.

### DETAILED DESCRIPTION OF THE PREFERRED EMBODIMENT

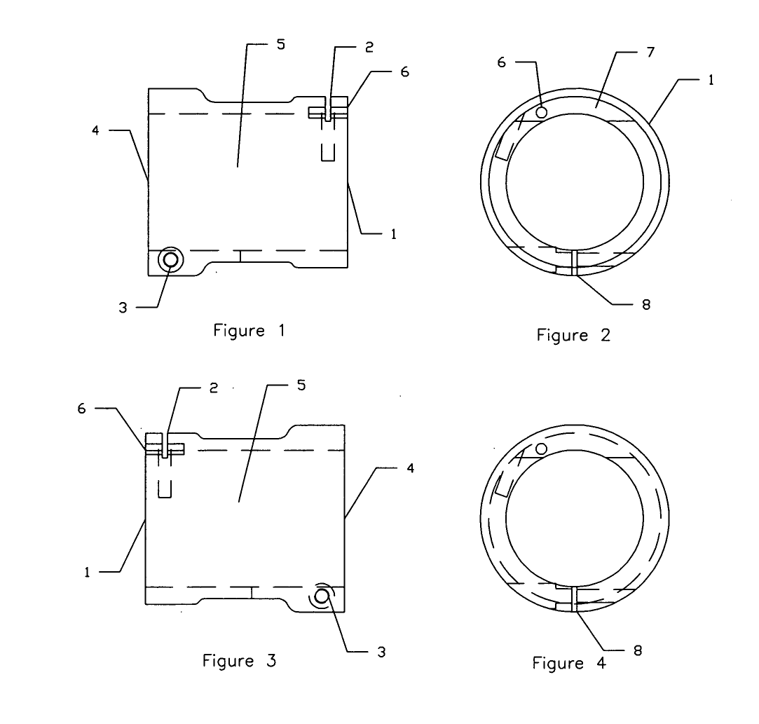

Starting with FIG. 1-4 there is an illustrated in FIGS. 1 & 3. an example of the Kiser Coupler which is embodied as mount body 5 which provides a lever divot 2, a roll pin hole 6 and a screw location 3 for the proper function of the mount as an assembly. FIG. 2. shows the forward shoulder 7 which is the indexing point for the mount body 5 when it is being affixed to an Aimpoint 9. Further depicted is the fore end 1, a top view of the roll pin hole 6. FIG. 4 depicts a bottom view of mount body 5 illustrating the location and orientation of retention cut 8.

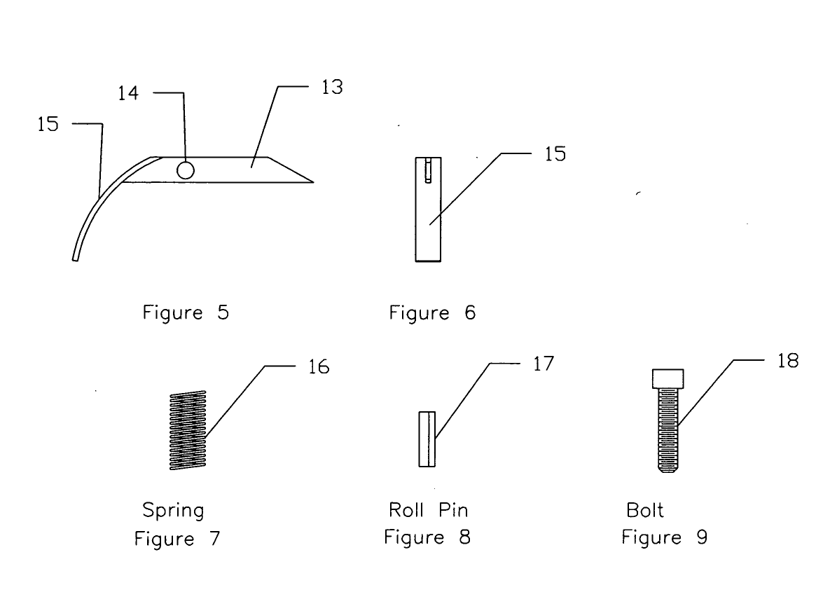

In FIG. 5-9 there are illustrations of the variety of small parts which are affixed to the mount body 5 which are necessary to its proper function. FIG. 5 depicts a lever 13, lever axis pin 14, and lever handle 15. FIG. 6 shows a rear view of the lever handle 15. Lever spring 7 is provided to put pressure on lever 13. Roll pin 17 secures lever 13 through lever axis hole 14 and functions as an operational system. Screw 18 is threadedly secured into the screw location 3 (FIGS. 1 & 3).

Illustrated in FIG. 10 is a horizontal side view of an Aimpoint 9, proposed “Kiser Coupler” mount body 5, and a 3x magnifier 12. a represents the longitudinal axis of the above listed items. A machined circumferential groove 10 is present on the rear of Aimpoint 9. 3x magnifier 12 provides a forward mounting surface 11 to which mount body 5 is secured.

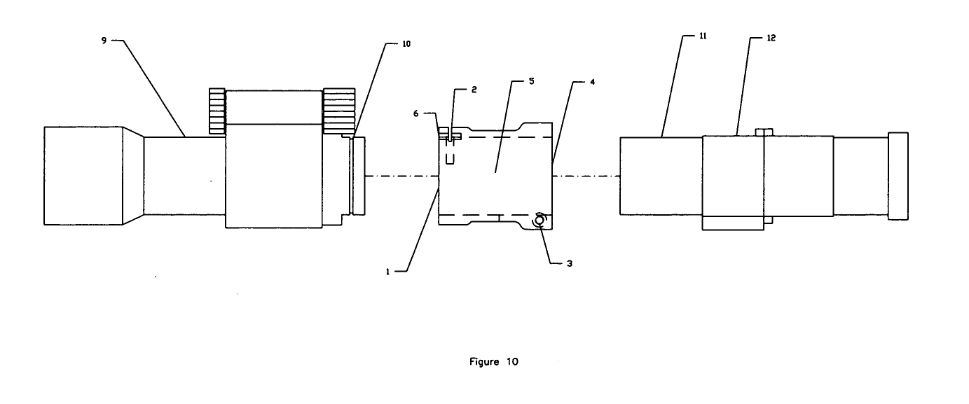

As used herein, the word “front” or “forward” corresponds to the direction of which the proposed mount would be while mounted to an Aimpoint optical gun site (i.e., to the right as shown in FIG. 1 or left of FIGS. 3, 9); “rear” or “rearward” or “back” corresponds to the direction that the coupler is oriented when mounted to the Aimpoint optical gun site (i.e., to the left as shown in FIG. 1, or right of FIGS. 3, 9); “longitudinal” means the direction along or parallel to the longitudinal axis a of the Aimpoint 9, or 3x magnifier 12; and “transverse” means a direction perpendicular to the longitudinal direction.

Mount body 5 is affixed to the forward 3x mount surface 11 and held in place thru tension placed on the retaining cut 8 by means of threadedly securing screw 18 into screw location 3.

Upon such installation, the mount body 5 is fixedly secured to the 3x magnifier 12 both longitudinally and threadedly.

Lever 13 is affixed to mount body 5 through the use of roll pin 17. Lever axis hole 14 is the pivot point by which lever 13 rotates in lever divot 2. Spring 16 pushes against lever 13 and maintains lever 13 in its closed position unless lever handle 15 is depressed reliving lever spring 16 of tension which results in the rotation of lever 13 out of lever divot.

Once mount body 5 is secured to the 3x magnifier 12 the end user may interface the mount onto the rear of an Aimpoint 9. By depressing lever handle 15 lever 13 will rotate out of lever divot 2. The mount body 5 and 3x magnifier 12 system may then be slip forward over the rear of the Aimpoint 9. Forward shoulder 7 will provide a firm stop point allowing the end user to know when the mount body 5 is fully seated. Lever handle 15 will be released thereby causing lever 13 to seat into the circumferential groove 10 which is located about the rear of Aimpoint 9. For end 1 will prevent movement of mount body 5 which is transverse to the longitudinal axis a while lever 13 which is resting within circumferential groove 10 will prevent mount body 5 from disengaging with Aimpoint 9 circumferential groove 10 due to vibrations which result from the discharge of a firearm.

To remove mount body 5 from Aimpoint 9 lever handle 15 is depressed causing lever 13 to rotate into open position thereby releasing it from circumferential groove 10. Mount body 5 is then pulled to the rear of Aimpoint 9 thereby releasing tension placed on Aimpoint 9 from fore end 1 and forward shoulder 7.

Thus, there has been described a preferred embodiment of an apparatus for quickly, and reliably securing a 3x magnifier 13 to the body of an Aimpoint 9 and for quickly and easily removing the proposed mount body 5 from the Aimpoint 9, as well as a method for such attachment. Other embodiments of the present invention, and variations of the embodiment described herein, may be developed without departing from the essential characteristics thereof. Accordingly, the invention should be limited only by the scope of the claims listed below.

### CONCLUSION, RAMIFICATIONS, AND SCOPE

Accordingly the reader will see that, according to the invention, I have provided a secure retention system which will prevent a 3x magnifier from backing off as a result of the vibrations incidental to the use of a firearm. Further it can be seen that my preferred embodiment of this invention provides a method and apparatus which do not require the use of a Picatinny rail for use and operation. I have also afforded any user of my invention the ability to single handedly remove or attach the noise suppressor with one hand.

While my above drawings and description contain many specificities, these should not be construed as limitations on the scope of the invention, but rather as an exemplification of one preferred embodiment thereof.

Accordingly, the scope of the invention should be determined not by the embodiments illustrated, but by the appended claims and their legal equivalents.

1. A mount for the Aimpoint 3x magnifier comprising:
a: a cylindrical housing which is tensioned fitted to the external housing of an Aimpoint 3x magnifier, and
b: a locking lever which is attached to said cylindrical housing which will interface with the circumferential cut around the Aimpoint optic, and
c: means for joining said cylindrical housing to said housing of the Aimpoint 3x magnifier
whereby said cylindrical housing will securely restrain the Aimpoint 3x magnifier and through the use of said locking lever attach externally to the rear of an Aimpoint optical gun site.

2. The cylindrical housing of claim 1 wherein said housing has a vertical cut which has a screw threadedly secure to the body running transverse to the said cut.

3. The locking lever of claim 1 wherein said lever rotates on a pin and depends on spring pressure to hold said lever in a down position,
whereby said locking lever is provided a means to lock into circumferential cut locating about the body of an Aimpoint optical gun site and prevent said cylindrical housing from displacement due to the incidental vibration which result from the discharge of a firearm.

4. The cylindrical housing of claim 1 wherein said housing has a forward opening which will snugly fit about the external housing of an Aimpoint optical gun site.

5. A method of mount an optical gun site magnifier to an optical gun site:
a: providing said optical gun site, and gun site magnifier and positioning them with the front of said magnifier facing the rear of said optical gun site, and
b: providing a cylindrical housing which is affixed to the body of said optical gun site magnifier which a spring tensioned lever, and
c: depressing said locking lever and pressing said cylindrical housing over the rear of said optical gun site and releasing locking lever into a grove located about the external surface of said optical gun site.
